(19) United States
(12) Patent Application Publication
(10) Pub. No.: US 2001/0027472 A1
(43) Pub. Date: Oct. 4, 2001

(54) Dynamic information sharing based on unique individual ID

(76) Inventor: Feng Guan, Glenview, IL (US)

Correspondence Address: Feng Guan, 2600 Golf Road, # 705, Glenview, IL, 60025, US

(21) Appl. No.: 09/817,875

(22) Filed: Mar. 26, 2001

Related U.S. Application Data
(60) Provisional application No. 60/192,722, filed on Mar. 27, 2000.
(60) Provisional application No. 60/227,812, filed on Aug. 25, 2000.

(51) Int. Cl. G06F 15/16

(52) U.S. Cl. 709/203

(57) ABSTRACT

InfoID system enables a user to dynamically share his/her information (such as address, electronic business card, documents, records, schedules, etc.) with others by using his/her unique information ID. A user can create or update his/her information (data), use this information multiple times without reentry of the data, and share this information with others instantly (or dynamically). The user has the full control of how his or her information can be accessed by other people. The main application is a database-driven, Internet-based application. A complementary desktop application will be created to allow users to retrieve information off line by using the local database. A wireless hand-held device will be created to allow users exchange their information or information ID between these devices. They can also use this device to communicate with the web-base application, as well as to synchronize with the desktop application.

This application is base upon Provisional Patent Application Serial No. 60/192,722 filed Mar. 27, 2000 and Provisional Patent Application Serial No. 60/227,812 filed Aug. 25, 2000.

### BACKGROUND AND SUMMARY OF THE INVENTION

The present invention relates to dynamic information sharing with unique ID. The main application is a database-driven, Internet-based application. A complementary desktop application will be created to allow users to retrieve information off line by using the local database. A wireless hand-held device will be created to allow users exchange their information or information ID between these devices. People can also use these devices to communicate with the web-base application, as well as to synchronize with the desktop application.

Internet use is expanding at rapid rate, particularly with information sharing. However, information is not shared dynamically in most cases.

The First Dilemma:

I once had a lot of friends and wrote down their name and contact information in my address book. When time went by, I lost contact of some of my best friends because they moved and they never notified me. Maybe they lost my address, too. Last year, I went to San Francisco. When I came back, I couldn't find my address book. That was one of the most miserable days I've ever had.

The Second Dilemma:

Through my professional career, I have accumulated more than 300 business cards of other people. Sometimes I can't find the cards I need because I have so many of them. I have about 200 my own business cards, and always have difficulty to decide how many cards I should bring with me. Most of time I would run out of my cards in the conference. When I moved to a new position or joined another company, I had to wait 2 weeks for another 200 cards. What a headache!

There are other situations that we would love to have information shared dynamically.

Would it be nice if we have a central place to store all these information, which can be shared by all related parties? When this information changes, all related parties could have the access to the new information immediately.

According to the present invention, InfoID system will enable a user to dynamically share his/her information (such as address, electronic business card, documents, records, schedules, etc.) with others by using his/her unique information ID. A user can create or update his/her information (data), use this information multiple times without reentry of the data, and share this information with others instantly (or dynamically). The user has the full control of how his or her information can be accessed by other people. The main application is a database-driven, Internet-based application. A complementary desktop application will be created to allow users to retrieve information off line by using the local database. A wireless hand-held device will be created to allow users exchange their information or information ID between these devices. They can also use this device to communicate with the web-base application, as well as to synchronize with the desktop application.

According to an exemplary embodiment of the invention, a method of developing a portal for dynamic information sharing with unique ID over a computer network includes

(a) Generating a home page

I. where a user can log in to the InfoID portal;

II. with links to web pages that are relevant to the specific dynamic information sharing services, and functions/features, wherein one of the links is a registration link to a registration page where a user can register with the portal;

(b) Providing links to dynamic information sharing (based on unique ID) services, such as “personal information”, “E-business card”, “medical records”, “emergency information”, “alumni directory”, “church membership directory”, “user defined group”, “instant electronic mail”, “one-click registration/enrollment”, “kids ID” and “pet ID”, after a user logged in;

(c) Providing links to functions, such as “search”, “view information”, “request information”, “approve request”, “request status” and “access control”.

In accordance with another exemplary embodiment of invention, a computer system is provided for maintaining InfoID system. A computer system includes at least one user computer running a computer program that requests information according to his/her unique ID. A system server running a server program is connected with the at least one user computer by a computer network. The system server sends the requested information according to the user's unique ID and enables a user via the user computer to receive dynamically shared information.

### BRIEF DESCRIPTION OF THE DRAWINGS

These and other aspects and advantages of the present invention will be described in detail with reference to the accompanying drawing, in which:

FIG. 1 is a schematic illustration of a network environment in conjunction with the present invention;

FIG. 2 is a schematic block diagram of the web site architecture according to the present invention; and

FIG. 3 is a schematic block diagram of a computer.

### DETAILED DESCRIPTION OF PREFERRED EMBODIMENTS

1. Circumstances of Conception

The First Dilemma:

I once had a lot of friends and wrote down their name and contact information in my address book. When time went by, I lost contact of some of my best friends because they moved and they never notified me. Maybe they lost my address, too. Last year, I went to San Francisco. When I came back, I couldn't find my address book. That was one of the most miserable days I've ever had.

The Second Dilemma:

Through my professional career, I have accumulated more than 300 business cards of other people. Sometimes I can't find the cards I need because I have so many of them. Sometimes, some of those business cards became obsolete because their owners moved to new positions or joined other companies. I have about 200 my own business cards, and always have difficulty to decide how many cards I should bring with me. Most of time I would run out of my cards in the conference. When I moved to a new position or joined another company, I had to wait 2 weeks for another 200 cards. What a headache!

There are other situations that I would love to have information shared dynamically.

Would it be nice if we have a central place to store all these information, which can be shared by all related parties? When this information changes, all related parties could have the access to the new information immediately.

2. Purpose:

To provide a set of application(s) and device(s) that can enable individuals to dynamically share his/her information (such as address, electronic business card, documents, records, schedules, etc.) with others by using his/her unique information ID (I call it INFOID). The purpose of this invention is for individuals to create or update the information (data), use this information multiple times without reentry of the data, and share this information with others instantly (or dynamically). The individual will have the full control of how his or her information can be accessed by other people.

3. Description:

The main application (will be refereed as the application) is a database-driven, Internet-based application, which can be accessed via a web site. This application allows an information owner to create and update his/her information (address, phone number, records or documents, etc.) in the central database (or repository) via a web browser, such as Netscape Navigator or Microsoft's Internet Explorer, with his/her unique information ID (INFOID). Instead of giving people his/her information, the information owner can give his/her friends and business associates (which will be refereed as information requesters) his/her information ID (INFOID). The information requesters then can use the same application to request the access to this information owner's information by login to the same web site via their own web browsers. The application will allow the information owner to grant the access rights (with multi-level securities) of his/her information to these information requesters, identified by their own information ID (INFOID), via the web site.

Here are the different levels of the securities that an information owner could choose.

1^{st} priority—The information requester will have the access right to the current information, as well as the updated information in the future.

2^{nd} priority—The information requester will have the access right to the current information only, not the updated information in the future.

3^{rd} priority—The information requester will have no access right to any information.

There could be other levels of security based on the usage of this invention.

These different security levels can be applied to any information requester who wants to have the access to a particular record of the owner's information. The information owner can also apply different security levels to different time period. For example, the owner can grant a requester the access rights with the 2^{nd} priority to the owner's address information from Jan. 1, 2000 to Jun. 1, 2000. The owner can grant the same requester the access rights with the 1^{st} priority to the owner's address information from Jun. 2, 2000 to Dec. 1, 2000. The owner can grant no access right to the same requester beyond these two time periods specified above.

A dynamic link will be created between this information owner and information requesters by the application as soon as the information owner grants the access permission to the requesters.

Thus, the information requesters can have immediate access to the owner's information via the web site. Next time, when the information owner change his/her information in the central database via the web site, the application will send a notice, such as an email or a regular mail, to the information requesters with 1^{st} priority who have links to these information. These information requesters will have the instant access to the updated information. Thus, we can achieve the goal of dynamical information sharing by using this web-based application. The information owner can even grant the access rights to certain people in advance (pre-approved list) if he or she knows requesters' information Ids (INFOID). As a result, the communication and information exchange will be more efficient and effective.

To complement the web-based application (which is a server-side application), a desktop application (client-side application) will be created to take the full advantage of the dynamic information sharing. This desktop application will use a local database, which can be synchronized with the central database via web, whenever the user wishes, for easier access to the information and easier data entry. It also can be used in the case that an Internet connection isn't available. This desktop application has the same functionality and features as those of web-based application, except the desktop application uses the local database.

A wireless hand-held device will be created to take this information sharing technology to the next level. People can exchange their information or information IDs (INFOID) between these devices with the help of wireless technology. They can also use this device to communicate with the web-based application, as well as to synchronize with the desktop application.

In the near future, I envision that everyone (including companies and organizations) will have his or her own unique information ID (INFOID) for the communication purposes. Instead of exchanging information, (such as phone numbers, addresses, or business cards, etc.) people (or organizations) will exchange their information ID (INFOID).

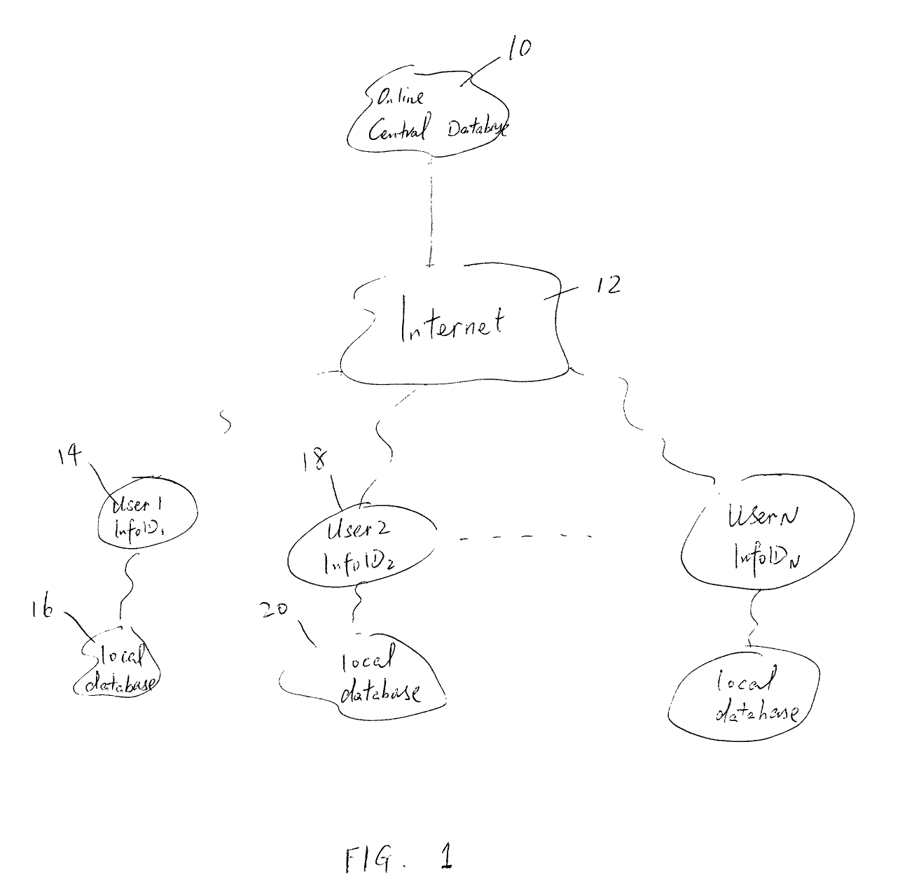

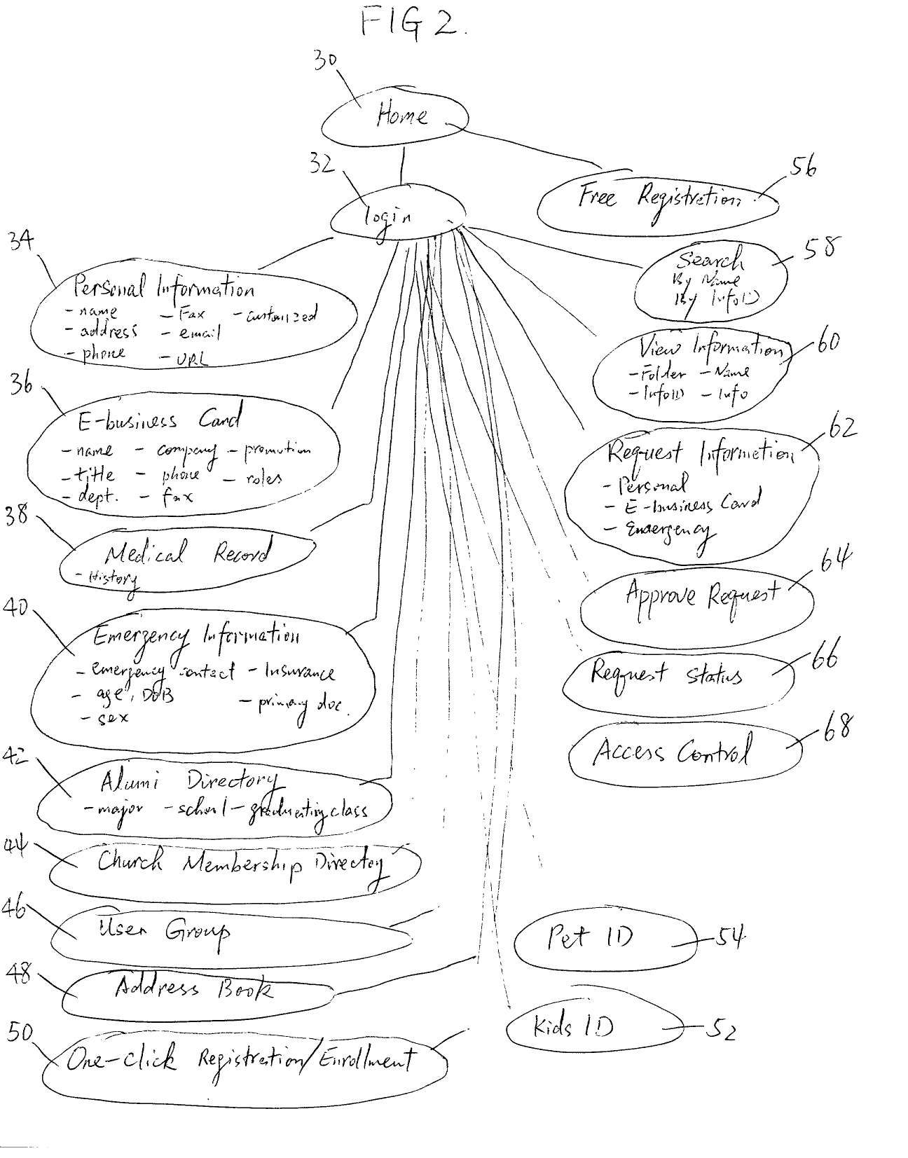

The InfoID system implemented in the diagrams of FIGS. 1 and 2 is preferably a browser-based system in which a program running on a user's computer (the user's web browser) requests information from a server program running on a system server. The system server sends the requested data back to the browser program, and the browser program then interprets and displays the data on the user's computer screen. The process is follows:

1. The user runs a web browser program on his/her computer.

2. The user connects to the sever computer (e.g., via the Internet). Connection to the server computer may be conditioned upon the correct entry of a password.

3. The user requests a page from the server computer. The user's browser sends a message to the server computer that includes the following:

The transfer protocol (e.g., http://): and

The address, or Uniform Resource Locator (URL)

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once data is retrieved, the browser formats the data and displays the data on the user's computer screen. Helper applications, plug-ins, and enhancements such as Java enable the browsers, among other things, to play sound and/or display video inserted in the HTML file. The fonts installed on the user's computer and the display preferences in the browser used by the user determine how the text is formatted.

If the user has requested an action that requires running a program (e.g. a search), the server loads and runs the program. This process usually creates a custom HTML page “on the fly” that contains the results of the program's action (e.g., the search results), and then sends those results back to the browser.

Browser programs suitable for use in connection with the InfoID system of the present invention include Netscape navigator available from Netscape Communications Corporation and Internet Explorer available from Microsoft Corp.

While the above description contemplates that each user has a computer running a web browser, it will be appreciated that more than one user could use a particular computer terminal or that a “kiosk” at a central location (e.g., a cafeteria, a break area, the local library, etc.) with access to the system server could be provided.

It will be recognized by those in the art that various tools are readily available to create web pages for accessing data stored on a server and that such tools may be used to develop and implement the Infold system described below and illustrated in the accompanying drawings.

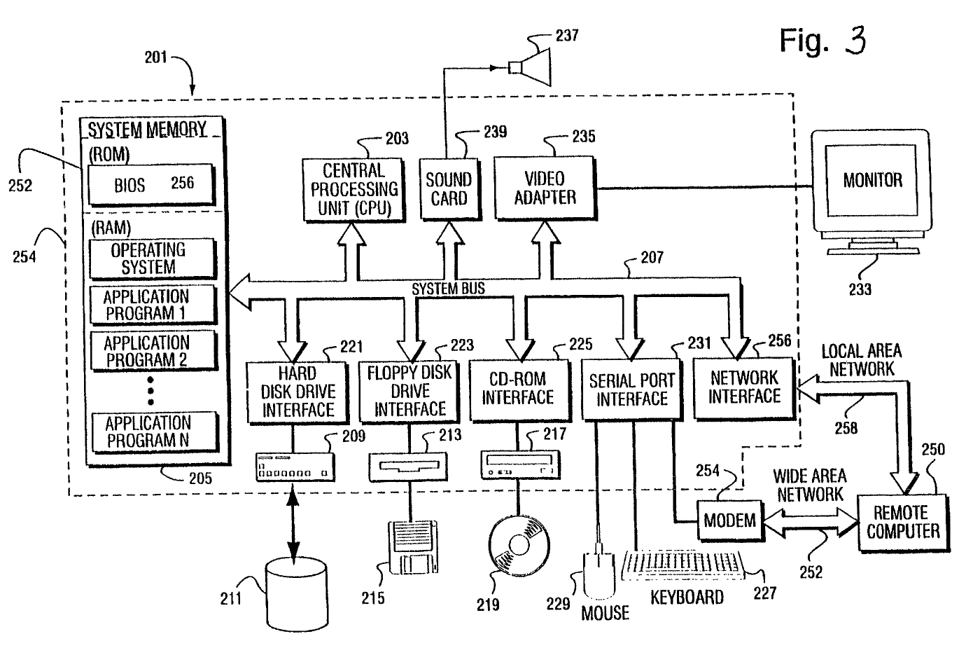

FIG. 3 generally illustrates a computer system 201 suitable for use as the client and server components of the InfoId system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 read from and writes to removable “floppy” or other magnetic disk 215; and an optical disk drive 217 read from and, in some configurations, writes to removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g. magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite disk, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as video adapter 235.

The computer system 201 may also include a modem 254 or other means for establishing communications over the wide area network 252, such as the Internet. The modem 254, which may be internal or external, is connected to the system bus 207 via the serial port interface 231. A network interface 256 may also be provided for allowing the computer system 201 to communicate with a remote computing device 250 via local area network 258 (or such communication may be via the wide area network 252 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be sued, and the invention is not limited in this respect.

FIG. 1 is a network environment illustrating the principles according to the present invention. User1 14 with InfoID1 can input all his/her information to online central database 10 via Internet 12. User2 18 with InfoID2 can input all his/her information to online central database 10 via Internet 12. Then User1 14 can request information 62 (referring to FIG. 2) from User2 18. User2 18 can approve request 64 from user1 14 by assigning access level to each field of his/her own record. User1 14 can check the request status 62 to see if access has been granted. After obtaining access to user2's 18 information, user1 14 can view information 60 to get user2's 18 information. If user2 18 wants to block access or change access level from User1 14, he/she can go to access control 68 to do so. User1 14 can make a replicate of his/her records in the central database 10 to his/her local database 16. Thus, user1 14 can search this local database 16 for the contact information without going to the Internet. User2 18 can make a replicate of his/her records in the central database 10 to his/her local database 20. Thus, user2 18 can search this local database 20 for the contact information without going to the Internet.

Referring to FIG. 2, a “personal information” link 34 enables a user to create, update and edit his/her personal profile. The personal file includes his/her name, address, work phone number, home phone number, cellular phone number, email addresses, web page URL, and customized fields, etc. A user can also define the access level for each of the field mentioned above.

Referring to FIG. 2, a “E-business card” link 36 enables a user to create, update and edit his/her business profile. The business profile includes his/her name, title, department name, company name, business address, work phone number, fax number, cellular phone number, email addresses, web page URL, his/her roles and responsibilities, product and services, promotions, and customized fields, etc. A user can also define the access level for each of the field mentioned above.

A “medical record” link 38 enables a user to create, update and edit his/her medical record.

A “emergency information” link 40 enables a user to create, update and edit his/her emergency information record. The emergency information record includes his/her name, address, age, sex, date of birth, his/her emergency contact information (such as spouse and relative's contact information), primary physician's information, medical history, and insurance information, etc.

An “alumni directory” link 42 enables a user to create, update and edit his/her alumni information which may include following:

(a) elementary school (name and ID) and graduating class

(b) high school (name and ID) and graduating class

(c) university/college (name and ID), graduating class, degree earned, major and minor.

A “church membership directory” link 44 enables church to share information among its members by inviting its members to join the directory.

A “user group” link 46 enables a user to create his/her own user group.

An “address book” link 48 enables a user to create, update and edit his/her own address book.

A “one-click registration/enrollment” link 50 enables a user to register with a conference (or exhibition, show etc.) or enroll to an insurance program (or magazine subscription program, a school or a college, etc.) with a single click.

A “kids ID” link 52 enables parents to identify their children by providing kids-related information, such as their parents contact information, home address, etc.

A “pet ID” link 54 enables pets owners to identify their pets by providing pets-related information, such as their owners' contact information, home address, etc.

A “free registration” link 56 allows a user to register with the InfoID system portal and obtain his/her own information ID (InfoId), which can be used for various communication purposes.

4. Usage (Application):

A) Dynamic “personal information” (address, phone, fax, email, etc.) sharing.

An information owner (Jeff) can come to my web site (Accessmyinfo.com or a different URL I may choose) to register with his personal information (such as address) and business information (such as information on his/her business card). He can create his own information ID (INFOID) and PASSWORD for protection. He then can give his friend (Joann) his information ID (INFOID). With the help of the wireless hand-held device, Jeff and Joann can exchange their information or information IDs (INFOID) between their devices. In this case, no paper or writing will be needed.

Joann can then go to my web site (Accessmyinfo.com) and log in with her own information ID (INFOID) and PASSWORD and request access to Jeff's personal information (such as address). A notice, such as an email, will then send to Jeff and notify him the request. Jeff logs in to the Accessmyinfo.com and grant Joann the access right with the correct level of security (2nd priority—just current information or 1^{st} priority—including the future information) if he wishes to do so. If the request is from somebody Jeff doesn't know, he can reject the request.

When Jeff moves to a new location, he can come back to my web site (Accessmyinfo.com) to update his private information (such as new address). As soon as he finishes it, all his friends with 1^{st} priority, who have links (access) to these information, will be notified and have the access to Jeff's updated information (his new address and phone number) instantly via my web site (Accessmyinfo.com). The application can allow them to accomplish this because all parties are using the same information in the central database.

With the help of this invention, Jeff will never lose contact with any of his friends who he wishes to keep touch with. Please notice that Jeff is the only one who enters the data into the central database. No reentry of the data is needed by any of his friends or associates. Thus, all the possible human errors during the reentry are eliminated.

By using the client-side application, Joann can have a replicate of her record in the central database on her own desktop. She can search this local database for the address information she needs without going to the Internet.

Jeff can also share his address information with financial institutions, such as credit card companies and banks, etc. so that he can be certain that he'll receive all the bills and statements, and don't miss a single payment. Jeff also can display his picture on his information page.

B) Dynamic “E-business card” exchange and managing.

An information owner (Jeff) can come to my web site (Accessmyinfo.com or a different URL I may choose) to register with his personal information (such as address) and business information (such as information on his/her business card). He can create his own information ID (INFOID) and PASSWORD for protection. He then can give his business associate (Joann) his information ID (INFOID). Joann can then go to Accessmyinfo.com and logs in with her own information ID (INFOID) and PASSWORD and request a link to Jeff's business information (electronic business card). A notice, such as an email or regular mail, will then send to Jeff and notify him the request. Jeff logs in to my web site (Accessmyinfo.com) and grant Joann the access right with the correct level of security (2nd priority—just current information or 1^{st} priority—including the future information) if he wishes to do so. If the request is from somebody Jeff doesn't know, he can reject the request. Jeff can also display his picture on his e-business card (the web page).

In this case, Joann doesn't have to keep hundreds of paper-based business cards to conduct her business. Instead, she has hundreds of links of business card information in her own database. Thus, Joann can search the business information in her database based on name, company, or location, or even industry. She will be a lot more efficient and effective.

When Jeff moves to a new position or joins another company, he can come back to my web site (Accessmyinfo.com) to update his business information. As soon as he finishes it, all his business associates or partners with 1^{st} priority will be notified and have the access to his updated business information instantly via my web site (Accessmyinfo.com), because they are using the same information in the central database.

By using the client-side application, Joann can have a replicate of her record in the central database on her own desktop. She can search this local database for the business information she needs without going to the Internet.

C) Dynamic “Medical Records” sharing.

Jeff went to see his doctor, Dr. Kurani in Illinois. Dr. Kurani examined Jeff and then input Jeff's medical data into the central database via my web site by using a web browser, such as Netscape Navigator or Microsoft's Internet Explorer, with her unique information ID (INFOID). Jeff's medical record is kept under Jeff's own unique information ID (INFOID) in the central database.

When Jeff moves to California, Jeff has to go to see a different doctor, Dr. Smith. Dr. Smith may ask Jeff for his past medical records, or ask Jeff to fill out a form Jeff may not understand. In this case, Jeff can give Dr. Smith his unique information ID (INFOID) and ask Dr. Smith or his assistant to send a request to Jeff for his medical record. Jeff can then go to my web site and grant the access right of his medical records to Dr. Smith. As soon as Jeff grants the permission, Dr. Smith will have instant access to the information he needs. Jeff can even grant Dr. Smith access to his medical records in advance if he knows Dr. Smith's information ID (INFOID) by setting this up via my web site.

Jeff can also grant access rights of his medical record in advance to certain doctors and emergency agencies for emergency situation, as long as Jeff has their unique information IDs (INFOID). Since Jeff always has his own information ID (INFOID) with him, doctors and emergency agencies can have access to his medical record immediately via my web site in the case of emergency.

D) “Emergency Information” Sharing.

An information owner (Jeff) can come to Accessmyinfo.com (or a different URL I may choose) to register with his personal information (such as address) and business information (such as information on his/her business card). He can create his own information ID (INFOID) and PASSWORD for protection. Jeff can then create his own emergency information profile, which includes

1. His emergency contact information, such as his parent's (and brother's or wife's) name, address, phone number, email address, pager number, etc.

2. His primary doctor's information, such as name, address, phone number, email address, pager number, etc.

3. His medical information, such as name, age, sex, date of birth, address, blood type, allergies, medications, medical history, medical chart, insurance (medicare or medicaid) information, etc.

Jeff can grant access rights of his “Emergency Information” in advance to pre-approved authorities, such as his primary doctors, 911 operators, local police, fire department, hospital emergency room, paramedics, local poison control center, etc., around the world.

Jeff will keep his information ID (INFOID) with him all the time. He can keep it in his wallet, by wearing an InfoID bracelet, or necklace, or wristband, or a shirt with InfoID bar code, or carrying a driver licenses or personnel identification card with InfoID, or an adhesive label on his luggage, car, brief case, etc.

Jeff, who is a British, travels to Chicago, U.S., and has a medical emergency. Someone calls 911 and paramedics arrive. Paramedics can immediately obtain Jeff's emergency information by access the web site (Accessmyinfo.com) with Jeff's INFOID using the wireless Internet. Or paramedics can call 911 to ask operators to get this information for them. The proper care will be assured and Jeff's primary doctor can be contacted if necessary. Jeff's relatives will be notified as quickly as possible. Life can be saved with the availability of this information.

No matter what the Jeff's nationality is, no matter where he is or travel to, this crucial information will be available to the appropriate authorities, in case of emergency.

E) Dynamic “Alumni Directory.”

All schools and colleges maintain an alumni directory. The challenge is that some of the contact information in the directory is either lost or out dated.

An information owner (Jeff) can come to my web site (Accessmyinfo.com or a different URL I may choose) to register with his personal information (such as address) and business information (such as information on his/her business card). He can create his own information ID (INFOID) and PASSWORD for protection. He then can give his college or any other organization his information ID (INFOID). The organization can then go to my web site (Accessmyinfo.com) and log in with its own information ID (INFOID) and PASSWORD, and then request a link (access) to Jeff's contact information. A notice, such as an email or regular mail, will then send to Jeff and notify him the request. Jeff logs in to the Accessmyinfo.com and grant the organization the access right (2nd priority—just current information or 1^{st} priority—including the future information) if he wishes to do so. If the request is from somebody Jeff doesn't know, he can reject the request.

If Jeff knows the INFOID of the college (high school or elementary school) he graduated from, he can send a request to the college to join that alumni directory (the group or community). The college can then grant him the permission to join the group after the validation of Jeff's eligibility. Thus, Jeff will have the access to the information of all members in the alumni directory, while other members will have access to Jeff's information.

If Jeff grants his access right to his college (high school or elementary school) with 1^{st} priority, the college will never lose contact with Jeff. The contact information in the alumni directory will be always current.

F) Dynamic “Church Membership Directory” sharing

All churches maintain a membership directory. The challenge is that some of the contact information in the directory is either lost or out dated.

An information owner (Jeff) can come to my web site (Accessmyinfo.com or a different URL I may choose) to register with his personal information (such as address) and business information (such as information on his/her business card). He can create his own information ID (INFOID) and PASSWORD for protection. He then can give his church or any other organization his information ID (INFOID). The organization can then go to my web site (Accessmyinfo.com) and log in with its own information ID (INFOID) and PASSWORD, and then request a link (access) to Jeff's contact information. A notice, such as an email or regular mail, will then send to Jeff and notify him the request. Jeff logs in to the Accessmyinfo.com and grant the organization the access right (2nd priority—just current information or 1^{st} priority—including the future information) if he wishes to do so. If the request is from somebody Jeff doesn't know, he can reject the request.

If Jeff knows the INFOID of the church he is associated with, he can send a request to the church to join that alumni directory (the group or community). The administrator from that church can then grant him the permission to join the group after the validation of Jeff's eligibility. Thus, Jeff will have the access to the information of all members in the church membership directory, while other members will have access to Jeff's information.

If Jeff grants his access right to his church with 1^{st} priority, the church will never lose contact with Jeff. The contact information in the church membership directory will be always current.

G) Instant Electronic Mail (iMail)

Today's e-mail system makes people life a lot easier than before. However, it has drawbacks. Just like regular mail, it takes time to reach the destination, thought it is much faster than regular mail. Furthermore, with the increasing traffic on the Internet, the sender of the email has no idea when the email will reach the receiver. The “Instant Electronic Mail” will solve this problem, and take the email communication to the next level, the “real time” communication level.

With the invention of “unique individual (including individual company and group) information ID”, we can make people's life even easier by providing “iMail” service.

An individual or information owner (Jeff) can come to my web site (Accessmyinfo.com or a different URL I may choose) to register. He can create his own information ID (INFOID) and PASSWORD for protection.

When and individual (Jeff) wants to send an instant mail (iMail) to another (Joann), he can login to my web site (Accessmyinfo.com or a different URL I may choose). He can send his mail to our central sever via Internet after he identify the receiver (Joann) by specifying (entering) her InfoID. As soon as the mail is sent, Joann will be able to retrieve the mail immediately because our central server is the final destination of the mail. Joann can login to my web site and views the message instantly via Internet.

Whenever an individual logins to my web site, they will see a personalized message indicating how many instant mails (iMail) are waiting for his viewing.

H) One-click on-line registration/enrollment (to conferences, shows, exhibitions, health care enrollment, school enrollment, etc).

To learn new technology and products, professionals go to a lot of conferences and exhibitions. They have to register with each conference and exhibition with the same information. This invention will allow registered users to do on-line registration with one click because all the information needed is in our on-line central repository. This invention can also apply to health care enrollment, insurance enrollment, school/college enrollment, magazine subscription, etc.

I) Kids ID

This invention will allow parents to identify and protect their children by obtaining unique Kids ID from our web site. They can let their children carry their KidID all the time. In emergency situation, authorized authorities can identify their children and obtain crucial information (such as their parents' contact information, primary doctor, etc.) by logging into our web site based on the kidsID.

J) Pet ID

This invention will allow pet owners to identify and protect their pets by obtaining unique pet ID from our web site. They can let their pets carry their petID all the time. In emergency situation, authorized authorities can identify their pets and obtain crucial information (such as their owners' contact information, etc.) by logging into our web site based on the unique petID.

There are other usages (applications) of this invention (based on INFOID), such as dynamic schedule sharing, enrollment and registration, employer record, school record, document sharing, dynamic issue tracking system, etc.

5. Possible Novel Features:

The Internet-based dynamic information sharing based on the unique individual information ID (INFOID) is believed entirely new. The web-based application (server-side application) based on information ID (INFOID) is believed entirely new. The desktop application (client-side application) based on the information ID (INFOID) is believed entirely new. The wireless hand-held device based on the information ID (INFOID) is also believed entirely new.

6. Advantages:

This invention will eliminate the need for multiple entry of the same information, and thus eliminate the possibility of human errors during this process. It enables individual to create or update his or her formation (data), use it multiple times without reentry of the data, and share this information with others instantly (or dynamically). It also gives individual full control of how his or her information can be accessed by other people. Since the data is stored in a central repository (database), which will have multiple backup copies stored in multiple locations, an individual will never need to worry about lose the data, even when there is a local disaster. His or her friends and business associates will always have the correct current information of this individual. Depending on their relationships (which determine their access priority), they may always have the correct information of this individual for the present and for the future if they have the access rights with1^{st} priority. With the security features, the individual can be sure that only the right person has the access to his or her information in the time period that he or she specified. The information owner can even grant the access right to certain people in advance if he or she knows their information IDs. Thus, the communication and information exchange will be more efficient and effective.

By using the client-side application, the user can manage his or her information without going to the Internet. The synchronization allows the user to make sure the local database has the same information as the central database.

The wireless hand-held device will really make paper-based business card obsolete. With this device, a user will never run out of his or her electronic business card. The user will also have the capability to communicate with other people and manage his or her information at any time and any place.

While the invention has been described in connection with what is presently considered to be the most practical and preferred embodiments, it is to be understood that the invention is not to be limited to the disclosed embodiments. On the contrary, it is intended to cover various modifications and equivalent arrangement included within the spirit and scope of the appended claims.

What is claimed is:

1. A method of developing a InfoID portal for both personal and business needs over a computer network, the method comprising:
(a) Generating a home page
I. where a user can log in to the InfoID portal;
II. with links to web pages that are relevant to the specific dynamic information sharing services, and functions/features, wherein one of the links is a registration link to a registration page where a user can register with the portal;
(b) Providing links to dynamic information sharing (based on unique ID) services, such as “personal information”, “E-business card”, “medical records”, “emergency information”, “alumni directory”, “church membership directory”, “user defined group”, “instant electronic mail”, “one-click registration/enrollment”, “kids ID” and “pet ID”, after a user logged in;
(c) Providing links to functions, such as “search”, “view information”, “request information”, “approve request”, “request status” and “access control”.

2. A method according to claim 1, wherein step (a) is practiced by generating the web page with links including a “personal information” link that enables a user to create, update and edit his/her personal profile.

3. A method according to claim 2, wherein the “personal information” link further enables the user to input and update his/her name, address, work phone number, home phone number, cellular phone number, email addresses, web page URL, and customized fields, etc. A user can also define the access level for each of the field mentioned above.

4. A method according to claim 1, wherein step (a) is practiced by generating the web page with links including a “E-business card” link that enables a user to create, update and edit his/her business profile.

5. A method according to claim 4, wherein the “E-business card” link further enables the user to input and update his/her name, title, department name, company name, business address, work phone number, fax number, cellular phone number, email addresses, web page URL, his/her roles and responsibilities, product and services, promotions, and customized fields, etc. A user can also define the access level for each of the field mentioned above.

6. A method according to claim 1, wherein step (a) is practiced by generating the web page with links including a “medical record” link that enables a user to create, update and edit his/her medical record.

7. A method according to claim 1, wherein step (a) is practiced by generating the web page with links including a “emergency information” link that enables a user to create, update and edit his/her emergency information record.

8. A method according to claim 7, wherein the “emergency information” link further enables the user to input and update his/her name, address, age, sex, date of birth, his/her emergency contact information (such as spouse and relative's contact information), primary physician's information, medical history, and insurance information, etc.

9. A method according to claim 1, wherein step (a) is practiced by generating the web page with links including a “alumni directory” link that enables a user to create, update and edit his/her alumni information.

10. A method according to claim 9, wherein the “alumni directory” link further enables the user to input and update following information:
(d) elementary school (name and ID) and graduating class
(e) high school (name and ID) and graduating class
(f) university/college (name and ID), graduating class, degree earned, major and minor.

11. A method according to claim 1, wherein step (a) is practiced by generating the web page with links including a “user group” link that enables a user to create his/her own user group.

12. A method according to claim 1, wherein step (a) is practiced by generating the web page with links including a “address book” link that enables a user to create, update and edit his/her own address book.

13. A method according to claim 1, wherein step (a) is practiced by generating the web page with links including a “search” link that enables a user search information in the database by individual's name or individual's InfoID.

14. A method according to claim 1, wherein “view information” link that enables a user to view his/her contact information.

15. A method according to claim 14, wherein the “view information” link further enables the user to view information in different folders, and create or edit folders.

16. A method according to claim 1, wherein “request information” link that enables a user to make a request to a person from whom he/she needs contact information.

17. A method according to claim 16, wherein the “request information” link further enables the user to request access to another user's personal information, and/or emergency information, and/or E-business card information.

18. A method according to claim 1, wherein “approve request” link that enables a user to approve a request from another user who wants to have access to his/her contact information.

19. A method according to claim 18, wherein the “approve request” link further enables the user to deny the access request, or approve the access request by assigning the access level to each field of his/her won information record.

20. A method according to claim 1, wherein “request status” link that enables a user to know the status of all request he/she has made in the past.

21. A method according to claim 20 wherein the “request status” link further enables the user to know the status of all request he/she has made in the past by providing “request date”, “response date”, “Infold of the person he/she made access request to”, “the name of the person he/she made request to” and the “status of that request” (such as rejected, approved, pending). The user can also cancel the pending request if he/she wishes to do so.

22. A method according to claim 1, wherein “access control” link that enables a user to control or change the access to his/her own information from other users whom have been approved to have access.

23. A method according to claim 22, wherein the “access control” link further enables the user to block the access to his/her own information by another user, or change the access level of another user to his/her own information.

24. A method according to claim 1, wherein “church membership directory” link that enables church to share information among its members.

25. A method according to claim 1, wherein “one-click registration/enrollment” link that enables a user to register with a conference (or exhibition, show etc.) or enroll to a insurance program (or magazine subscription program, a school or a college, etc.)

26. A method according to claim 1, wherein “kids ID” link that enables parents to identify their children by providing kids-related information, such as their parents contact information, home address, etc.

27. A method according to claim 1, wherein “pet ID” link that enables pets owners to identify their pets by providing pets-related information, such as their owners' contact information, home address, etc.

28. A computer system for dynamic information sharing based on unique individual ID. The computer system comprising:
(a) at least one user computer running a computer program that requests information according to a user's unique information ID.
(b) At least one system server running a server program, the at least one user computer and the system server being interconnected by a computer network, the system server sending the requested information according to the user's unique individual ID and enabling a user via the user's computer to retrieve information over the computer network.

29. A computer program embodied on a computer-readable medium for maintaining a InfoID system portal, the computer program comparing:
(a) means for generating a home page
I. where a user can log in to the InfoID portal;
II. with links to web pages that are relevant to the specific dynamic information sharing services, and functions/features, wherein one of the links is a registration link to a registration page where a user can register with the portal;
(b) means for providing links to dynamic information sharing (based on unique ID) services, such as “personal information”, “E-business card”, “medical records”, “emergency information”, “alumni directory”, “church membership directory”, “user defined group”, “instant electronic mail”, “kids ID” and “pet ID”, after a user logged in;
(c) means for providing links to functions, such as “search”, “view information”, “request information”, “approve request”, “request status” and “access control”.

30. A method of developing a desktop application that has the same functionality and features as those of web-based application we just discussed above. It will use a database residing on a user's computer instead of central on-line database. The local database can be synchronized with the central on-line database via web, whenever the user wishes.

31. A method of developing a wireless hand-held device that enables users to exchange their information for their unique information IDs. This device can be used to communicate with the web-based application, as well as to synchronize with the desktop application.
